(19) United States
(12) Patent Application Publication
(10) Pub. No.: US 2004/0239048 A1
(43) Pub. Date: Dec. 2, 2004

(54) Gasket, gasket formation method, and electrolysis apparatus using gasket

(76) Inventors: Hyung-Kwan Kim, Seoul (KR); Hyung-Mog Kim, Ulsan-city (KR)

Correspondence Address: LADAS & PARRY, 5670 WILSHIRE BOULEVARD, SUITE 2100, LOS ANGELES, CA, 90036-5679, US

(21) Appl. No.: 10/487,472

(22) PCT Filed: Jun. 7, 2002
(86) PCT No.: PCT/KR02/01085

(30) Foreign Application Priority Data
Apr. 16, 2002 (KR) 2002/20346

(51) Int. Cl. F16J 15/02

(52) U.S. Cl. 277/628

(57) ABSTRACT

A method for producing includes forming a gasket body (35), the gasket body including a center opening (40) and a plurality of passageways (45, 46), and forming connecting protrusions at areas defining the center opening if desired and select passageways; forming a Teflon member (47) that includes a connecting groove corresponding to a shape of the connecting protrusions; etching a surface of the Teflon member that will contact the gasket body, applying an adhesive to the gasket body and the Teflon member, and adhering the Teflon member to the connecting protrusions of the gasket body; placing the gasket body with the Teflon member adhered thereon in a mold and pressing the Teflon member to remove air between the gasket body and the Teflon member; and again placing the gasket member with the Teflon member adhered thereon in a mold and pressing.

### BACKGROUND OF THE INVENTION

(a) Field of the Invention

The present invention relates to a gasket used in an electrolysis apparatus, and more particularly, to a gasket having anticorrosive properties, a method for producing the gasket, and an electrolysis apparatus that uses the gasket.

(b) Description of the Related Art

Electrolysis is a process by which a solution is decomposed by passing an electric current through the solution such that separation of gases or metals occurs. Electrolysis is used in electroplating, wastewater treatment, and in the manufacture of sodium hydroxide (NaOH), which is widely used for industrial purposes.

Sodium hydroxide is a pure white solid that displays high alkalinity in an aqueous solution. In the manufacture of pulp, textiles, dyes, rubber, soap, etc., sodium hydroxide is commonly used as a raw material or as a desiccant that has exceptional deliquescing properties, which allows for the absorption of moisture in the air.

Methods for manufacturing sodium hydroxide include the Leblanc method in which sulfuric acid is added to crude salt and the mixture is decomposed by heating, and the ammonia soda method in which soda lime is reacted with Ca(OH)₂. The most commonly used method in recent times is a method by which brine undergoes an electrolytic process.

The different electrolysis techniques include the diaphragm process, the mercury process, and the ion-exchange membrane process.

In the diaphragm process, a diaphragm made of asbestos is provided between a graphite cathode and a steel anode such that no reaction takes place between chlorine leaving the cathode and sodium hydroxide leaving the anode to thereby obtain sodium hydroxide. However, a concentration of the sodium hydroxide made by the diaphragm process is only between 10 and 13% such that a condensation process must be performed repeatedly until the desired concentration is realized. Therefore, the diaphragm process is slow and tedious, making practical applications difficult.

In the mercury process, mercury is used as anode material to produce sodium hydroxide. However, because of the harm this heavy metal does to the environment, the mercury process is no longer used.

In the ion-exchange membrane process, an ion-exchange membrane is installed in an electrolytic cell to divide the electrolytic cell into a cation chamber and an anion chamber. In a state where a cathode plate and an anode plate are mounted respectively in the cation chamber and the anion chamber, electrolyte and water are filled in the cation and anion chambers, and power is supplied to the two plates such that chlorine gas is obtained from the cathode, and hydrogen and sodium hydroxide are obtained from the anode.

FIG. 1 is a schematic view of a conventional brine electrolysis apparatus that uses the ion-exchange membrane process.

The conventional brine electrolysis apparatus includes an electrolytic cell 11, a cation chamber 12, and an anion chamber 13. An ion-exchange membrane 14 is mounted in the electrolytic cell 11 to separate the cation chamber 12 and the anion chamber 13. Brine is supplied to the cation chamber 12 through a brine supply pipe 15, and pure water is supplied to the cation chamber 13 through a pure water supply pipe 16. A cation plate 17 and an anion plate 18 are provided in the cation chamber 12 and the anion chamber 13, respectively.

Further, a cation chamber exhaust tank 19 is connected to the cation chamber 12. The cation chamber exhaust tank 19 stores waste brine remaining after reaction in the cation chamber 12 and chlorine gas generated during electrolysis. A chlorine gas exhaust pipe 20 and a waste brine exhaust pipe 21 are connected to the cation chamber exhaust tank 19. Chlorine gas is exhausted through the chlorine gas exhaust pipe 20, and leftover brine remaining after reaction and unreacted brine are exhausted through the waste brine exhaust pipe 21.

An anion chamber exhaust tank 22 is connected to the anion chamber 13. The anion chamber exhaust tank 22 stores hydrogen gas and sodium hydroxide generated through reaction in the anion chamber 21. A hydrogen gas exhaust pipe 23 and a sodium hydroxide aqueous solution exhaust pipe 24 are connected to the anion chamber exhaust tank 22. Hydrogen gas stored in the anion chamber exhaust tank 22 is exhausted through the hydrogen gas exhaust pipe 23 and sodium hydroxide aqueous solution stored in the anion chamber exhaust tank 22 is exhausted through the sodium hydroxide aqueous solution exhaust pipe 24.

Such electrolysis apparatuses are used in various ways and are realized in various configurations. Korean Patent Publication No. 1985-0008084 discloses a filter press electrolytic cell that includes a plurality of cation chambers and anion chambers, and in which an ion-exchange membrane is provided between each pair of cation and anion chambers. A gasket is provided to each side of the ion-exchange membranes to thereby form the chambers, and a cation plate and an anion plate are provided to opposite sides of the each gasket. Hence, the chambers are formed in a successive configuration to realize the filter press electrolytic cell.

Each of the gaskets in the above filter press electrolytic cell is made of rubber and structured having a pair of through-holes formed on both side of a center hole. One of the through-holes allows the passage of chlorine gas or hydrogen and sodium hydroxide, and the other of the through-holes allows the passage of brine or pure water. Further, one of the two through-holes communicates with the center hole.

In the electrolysis apparatus using such gaskets, Na ions generated in the cation chambers pass through the ion-exchange membranes to combine in the anion chambers with OH ions having undergone electrolysis, thereby forming sodium hydroxide. During the electrolytic process, since the oxidation strength of the brine supplied via the through-holes and the chlorine gas generated in the cation chambers is significant, the gaskets corrode. If the corrosion continues, particles resulting from corrosion slowly enlarge such that the through-holes become blocked. Therefore, the volumes of the center holes and the through-holes of the gaskets are reduced over a period of time.

As a result, the circulation of brine via the through-holes does not occur as it should such that the performance of the electrolysis apparatus suffers. The apparatus may also completely malfunction. Rectifying this problem involves stoppage of the electrolysis apparatus, disassembly of the same, and removal of the particles. This is both time-consuming and difficult to perform.

### SUMMARY OF THE INVENTION

It is another object of the present invention to provide a gasket used in an electrolysis apparatus that does not easily corrode from contact with brine and chlorine gas.

It is one object of the present invention to provide a method for producing a gasket used in an electrolysis apparatus that does not easily corrode from contact with brine and chlorine gas.

It is still another object of the present invention to provide an electrolysis apparatus that uses a gasket that does not easily corrode form contact with brine and chlorine gas.

In one embodiment, the method for producing a gasket includes forming a gasket body using rubber, the gasket body including a center opening and a plurality of passageways, and forming connecting protrusions at areas defining the center opening if desired and select passageways; forming a Teflon member using an injection molding process such that the Teflon member includes a connecting groove corresponding to a shape of the connecting protrusions; performing an etching process on a surface of the Teflon member that will contact the gasket body using a solution in which Na and liquid ammonia are mixed, applying an adhesive to the gasket body and the Teflon member at areas where the gasket body and the Teflon member are to make contact, and adhering the Teflon member to the connecting protrusions of the gasket body; performing a pre-forming process, in which the gasket body with the Teflon member adhered thereon is placed in a mold and pressing is performed on the Teflon member such that air between the gasket body and the Teflon member is removed; and performing a completion process, in which the gasket member with the Teflon member adhered thereon is placed in a mold and pressing is performed.

The gasket is produced using the above method for producing a gasket, in which areas forming passageways and a center opening coming into contact with brine and chlorine gas is treated with Teflon to result in a Teflon member having a cross section in the shape of a square with one side removed.

The electrolysis apparatus includes a cathode gasket including a center opening at a center of a frame that contacts the cathode plate, a brine passageway formed on a first side of the frame for allowing the passage of brine, a pure water passageway formed on the first side of the frame for allowing the passage of pure water, a chlorine gas passageway formed on a second of the frame for allowing the passage of chlorine gas, a hydrogen gas passageway formed on the second side of the frame for allowing the passage of hydrogen gas, a brine connecting hole formed at a predetermined angle with respect to a long axis of the cathode gasket and between the brine passageway and the center opening, a gas connecting hole formed substantially parallel to the long axis of the cathode gasket and between the chlorine gas passageway and the center opening, and Teflon applied to surfaces defining the brine passageway, the center opening, and the chlorine gas passageway; an anode gasket including a center opening at a center of a frame that contacts the anode plate, a brine passageway formed on a first side of the frame for allowing the passage of brine, a pure water passageway formed on the first side of the frame for allowing the passage of pure water, a chlorine gas passageway formed on a second side of the frame for allowing the passage of chlorine gas, a hydrogen gas passageway formed on the second side of the frame for allowing the passage of hydrogen gas, a pure water connecting hole formed at a predetermined angle with respect to a long axis of the anode gasket and between the pure water passageway and the center hole, a hydrogen gas connecting hole formed substantially parallel to the long axis direction of the anode gasket and between the hydrogen gas passageway and the center opening, and Teflon applied to surfaces defining the brine passageway and the chlorine gas passageway; a sheet gasket mounted to an outer surface of the cathode plate to closely contact the ion-exchange membrane, an opening being formed at a center of the sheet gasket and Teflon being applied to a surface of the sheet gasket defining the opening; a chlorine gas exhaust unit communicating with the chlorine gas passageway, the chlorine gas exhaust unit including an exhaust hole at an upper portion thereof through which chlorine gas is exhausted, and including a waste brine exhaust hole and a circulation hole at a lower portion thereof; a brine supply pipe connected to a lower end of the chlorine gas exhaust unit and communicated with the brine passageway; a sodium hydroxide exhaust unit communicating with the hydrogen gas passageway, the sodium hydroxide exhaust unit including a hydrogen gas exhaust hole formed at an upper portion thereof through which hydrogen gas is exhausted, and including a sodium hydroxide exhaust hole and a circulation hole at a lower portion thereof; and a pure water supply pipe connected to a lower end of the sodium hydroxide exhaust unit and communicating with the pure water passageway.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a conventional brine electrolysis apparatus that uses the ion-exchange membrane process;

FIG. 2 is a perspective view of an electrolysis apparatus according to a preferred embodiment of the present invention;

FIG. 3 is a schematic view of an electrolytic cell of an electrolysis apparatus of FIG. 1;

FIG. 4 is an exploded perspective view of a unit comprising the electrolyte cell of FIG. 3;

FIG. 5 is a plan view of a cathode gasket of the unit comprising the electrolytic cell of FIG. 4;

FIG. 6 is a plan view of an anode gasket of the unit comprising the electrolytic cell of FIG. 4;

FIG. 7 is a sectional view taken along line A-A of FIG. 4;

FIG. 8 is a schematic view of a chlorine gas exhaust unit of the electrolysis apparatus of FIG. 2;

FIG. 9 is a schematic view of a hydrogen gas exhaust unit of the electrolysis apparatus of FIG. 2; and

FIG. 10 is flow chart of a method for producing a gasket according to a preferred embodiment of the present invention.

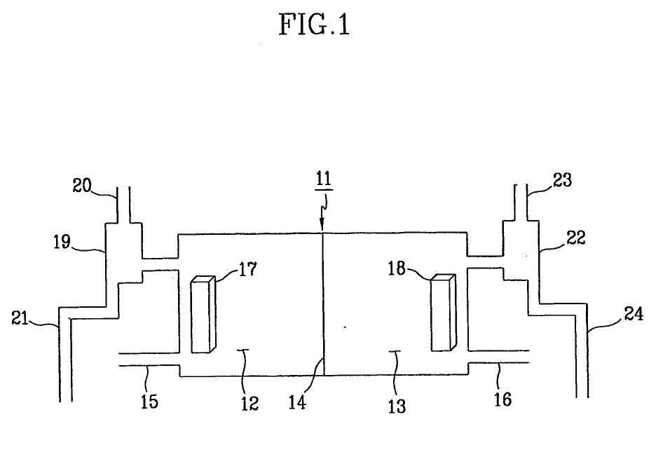

### DETAILED DESCRIPTION OF THE PREFERRED EMBODIMENTS

Preferred embodiments of the present invention will now be described in detail with reference to the accompanying drawings.

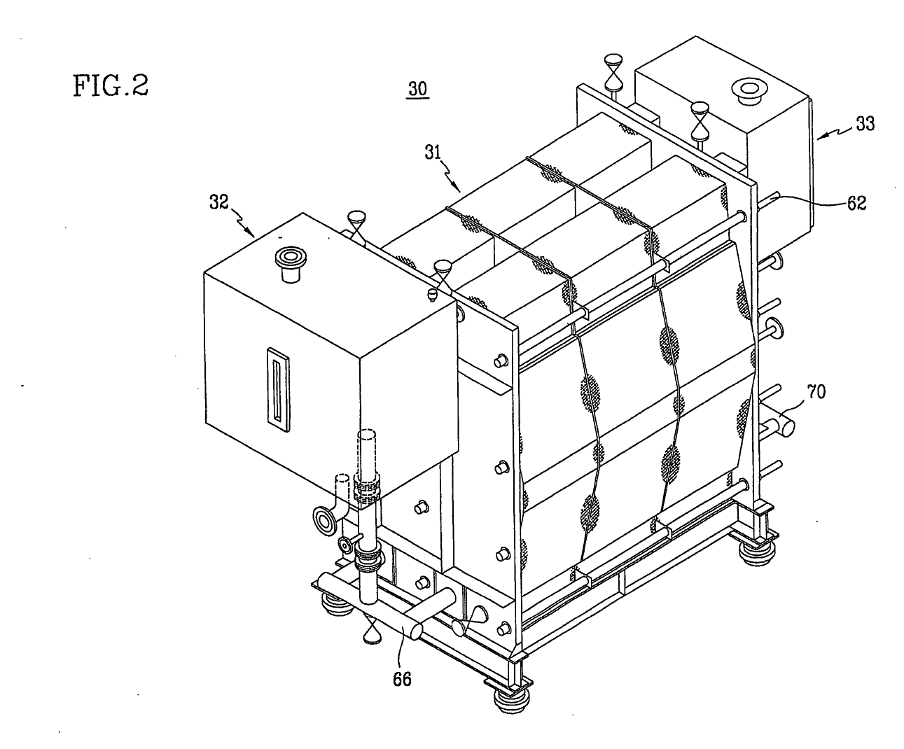

FIG. 2 is a perspective view of an electrolysis apparatus according to a preferred embodiment of the present invention. Reference numeral 30 indicates the electrolysis apparatus.

As shown in the drawing, the electrolysis apparatus 30 includes an electrolytic cell 31 comprised of individual units arranged successively, and a chlorine gas exhaust unit 32 and a sodium hydroxide exhaust unit 33 for collecting reactive gases and solutions generated in the electrolytic cell 31 and for exhausting the gases and solutions to outside the electrolytic cell 31.

A structure of the basic, individual units that comprise the electrolytic cell 31 will now be described.

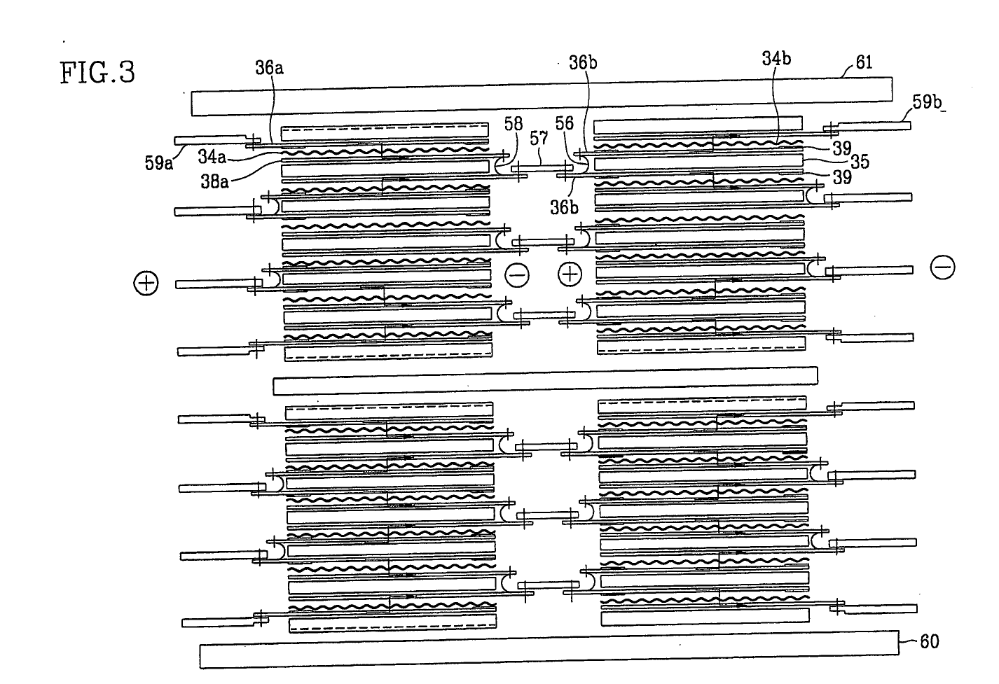

With reference to FIGS. 3-6, each of the individual units of the electrolytic cell 31 has a structure in which a cation chamber and an anion chamber are formed to opposite sides of an ion-exchange membrane 34. The cation chamber is filled with chlorine and the anion chamber is filled with pure water.

To realize one of the units, the cation chamber includes a plurality of anode plates 36 mounted with a anode gasket 35 interposed between each pair of anode plates 36, and the anion chamber includes a plurality of cathode plates 38 mounted with an cathode gasket 37 interposed between each pair of cathode plates 38. One of the ion-exchange membranes 34 is interposed between each adjacent pair of the anode plates 36 and the cathode plates 38. A sheet gasket 39 is mounted to an exterior of the outermost anode plates 36 to contact the ion-exchange membrane 34.

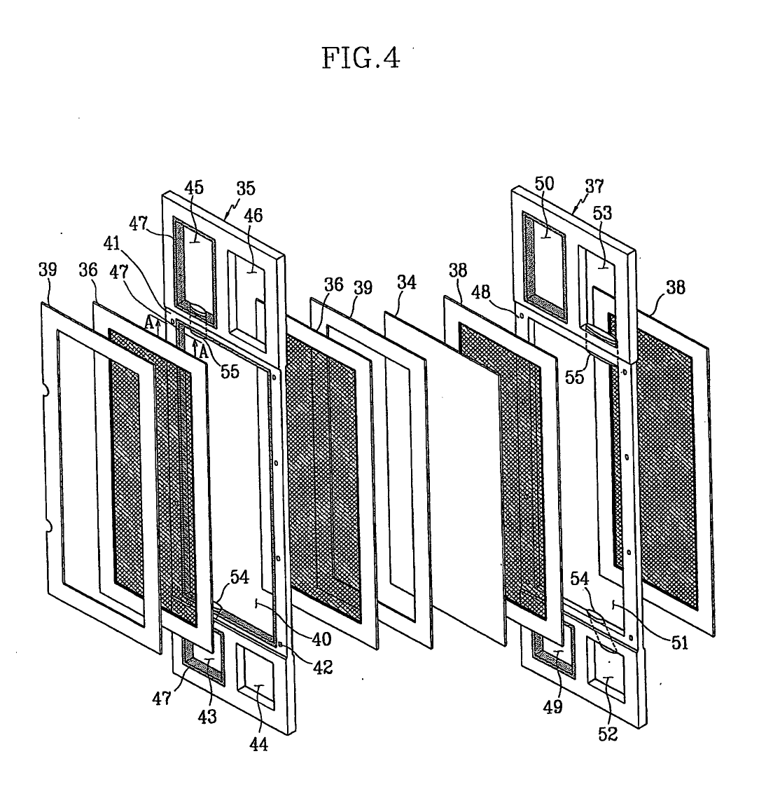

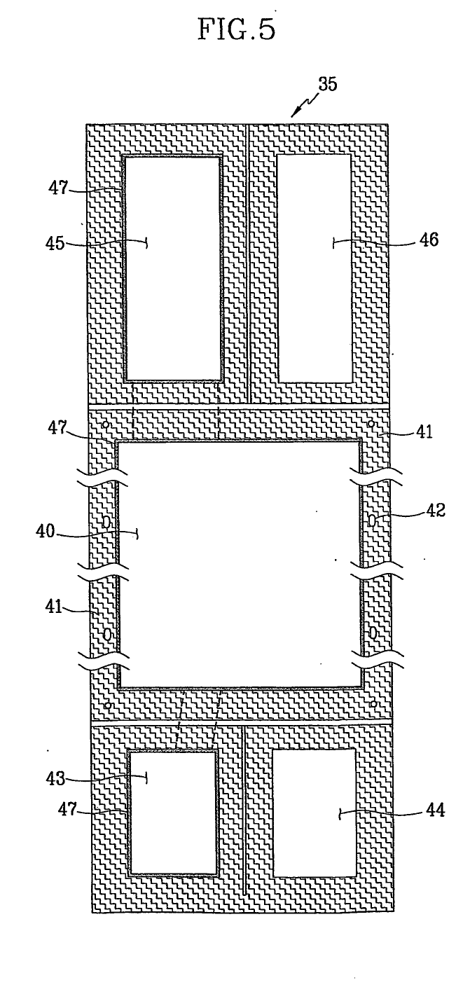

A basic structure of the anode gasket 35, with reference to FIGS. 4 and 5, is such that a solution movement section is formed to one side of a frame 41 that includes a center opening 40, and a gas movement section is formed to the opposite side of the frame 41. The frame 41 of the anode gasket 35 is not as thick as the solution movement section or the gas movement section. Connecting holes 42 are formed at predetermined intervals along long sides of the frame 41. Connecting pins formed in the anode plate 36 are inserted into the connecting holes 42 (this will be described in more detail below).

A plurality of minute protrusions is formed on surfaces of both sides of the frame 41. The protrusions are formed also on surfaces of both sides of the solution movement section and the gas movement section of the anode gasket 35.

The solution movement section of the anode gasket 35, with particular reference to FIGS. 4 and 5, includes a brine passageway 43 through which brine passes and a pure water passageway 44 through which pure water passes. The gas movement section of the anode gasket 35 includes a chlorine gas passageway 45 through which chlorine gas passes and a hydrogen gas passageway 46 through which hydrogen gas passes.

The brine passageway 43 and the chlorine gas passageway 45 of the anode gasket 35 communicate with the center opening 40 of the frame 41. This is realized through a brine connecting hole (shown by the dotted lines in FIG. 5) formed between the center opening 40 of the frame 41 and the brine passageway 43 of the solution movement section, and through a gas connecting hole (shown by the dotted lines in FIG. 5) formed between the center opening 40 of the frame 41 and the chlorine gas passageway 45 of the gas movement section. The brine connecting hole is formed with a center axis that is at an angle with respect to a long axis of the anode gasket 35, while the gas connecting hole is formed with a center axis that is substantially parallel to the long axis of the anode gasket 35.

The anode gasket 35 structured as in the above is coated with a Teflon member 47 at areas coming into contact with brine and chlorine gas. That is, surfaces of the frame 41, the solution movement section, and the gas movement section defining the center opening 40, the brine passageway 43, and the chlorine gas passageway 45, respectively, are coated with the Teflon member 47.

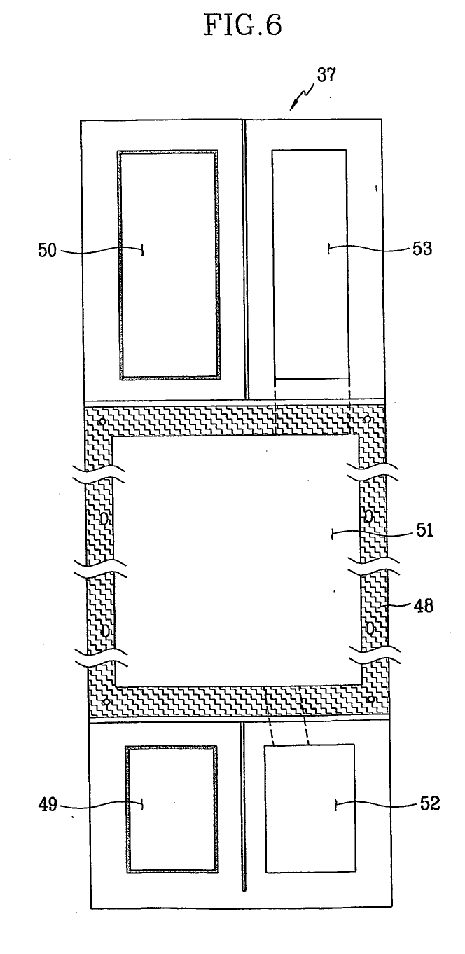

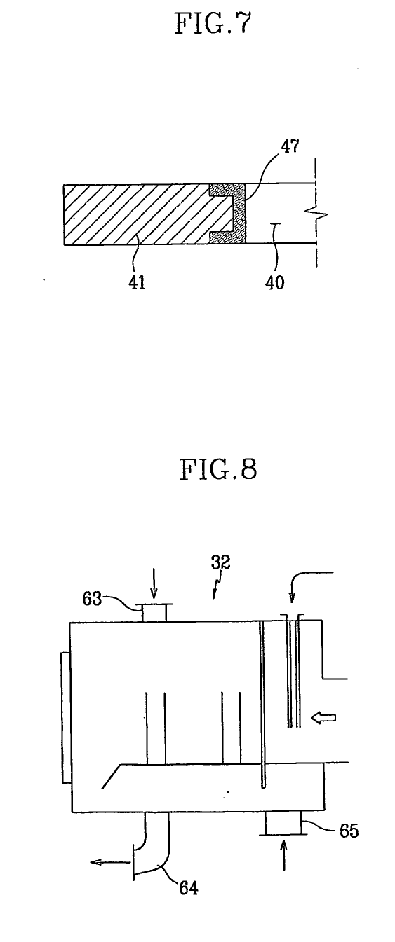

The Teflon member 47, with reference to FIG. 7, is formed at outermost ends of the surfaces of the of the frame 41, the solution movement section, and the gas movement section defining the center opening 40, the brine passageway 43, and the chlorine gas passageway 45, respectively, and extends a predetermined distance onto the frame 41, the solution movement section, and the gas movement section. FIG. 7 shows a section of the frame 41 with the Teflon member 47 adhered thereto in this configuration. Ends of the surfaces where the Teflon member 47 is provided are formed in a specific manner. This will be described below.

The cathode gasket 37, with reference to FIGS. 4 and 6, is formed similarly to the anode gasket 35. However, protrusions are formed only on a frame 48, that is, only on outer surfaces on both sides of the frame 48; a Teflon member 47 is coated over surfaces defining a brine passageway 49 and a chlorine gas passageway 50; and a pure water passageway 52 and a hydrogen gas passageway 53 are communicated with a center opening 51. The pure water passageway 52 is communicated with the center opening 51 through a pure water connecting hole (shown by the dotted lines in FIG. 6) that is formed with a center axis that is at an angle with respect to a long axis of the cathode gasket 37, and the hydrogen gas passageway 53 is communicated with the center opening 51 through a hydrogen gas connecting hole (shown by the dotted lines in FIG. 6) that is formed with a center axis that is substantially parallel to the long axis of the cathode gasket 37.

A metal distribution pipe 54 is inserted in the brine connecting hole formed between the brine passageway 43 and the center opening 40 of the anode gasket 35, and in the pure water connecting hole formed between the pure water passageway 52 and the center opening 51 of the cathode gasket 37. Also, a metal exhaust pipe 55 is inserted in the gas connecting hole formed between the chlorine gas passageway 45 and the center opening 40 of the anode gasket 35, and in the hydrogen gas connecting hole formed between the hydrogen gas passageway 53 and the center opening 51 of the cathode gasket 37.

The anode plates 36 are provided to both sides of the frame 41 of the anode gasket 35 as described above and at a size corresponding to the frame 41. Further, with reference to FIG. 3, the anode plates 36 are interconnected by a metal connecting member 56 to enable the flow of current therebetween. Also, one of the two anode plates 36 (a lower anode plate 36 in the drawing) is connected to an adjacent cathode plate 38 through a conducting plate 57 (this will be described in more detail below).

Similarly, the cathode plates 38 are provided to both sides of the frame 48 of the cathode gasket 37 as described above and at a size corresponding to the frame 41. The cathode plates 38 are interconnected by a metal connecting member 58 to enable the flow of current therebetween.

The sheet gaskets 39 are provided to surfaces of the anode plates 36 opposite those facing the frame 41 of the anode gasket 35 as described. The sheet gaskets 39 are almost identical in size to the anode plates 36 and include a large opening in a center thereof. Surfaces of the sheet gaskets 39 defining the openings are coated with a Teflon member, with a shape of the coating being like that shown in FIG. 7.

As shown in FIG. 3 and using a description that takes into account all the individual units of the electrolytic cell 31, positive (+) terminals are connected to left distributing bars 59a, which are connected to left anode plates 36a, and negative (−) terminals are connected to the left of the conducting plates 57, which are connected to left cathode plates 38a, between which are provided left ion-exchange membranes 34a, Positive (+) terminals are connected to the right of the conducting plates 57, and negative (−) terminals are connected to right distributing bars 59b, which are connected to right anode plates 36b between which are provided right ion-exchange membranes 34b.

The plurality of individual units of the electrolytic cell 31 is encompassed on one side by a fixed plate 60 and on an opposite side by a moveable plate 61. The fixed plate 60 and the moveable plate 61 interconnected by support bars 62 (see FIG. 2), ends of which pass through holes formed at corresponding locations in the opposing fixed plate 60 and the moveable plate 61.

The chlorine gas exhaust unit 32, with reference also to FIG. 8, is mounted to an outside surface of the fixed plate 60, that is, a surface of the fixed plate 60 facing away from the moveable plate 61. The chlorine gas exhaust unit 32 is communicated with the chlorine gas passageways 45 of the anode gaskets 35. The chlorine gas exhaust unit 32 includes an exhaust hole 63 formed at an upper portion of the chlorine gas exhaust unit 32 and through which chlorine gas is exhausted, and a waste brine exhaust hole 64 and a circulation hole 65 formed at a lower portion of the chlorine gas exhaust unit 32. A brine supply pipe 66 is connected to a lower end of the chlorine gas exhaust unit 32. An opposite end of the brine supply pipe 66 passes through the fixed plate 60 to be communicated with the brine passageways 43 of the anode gaskets 35.

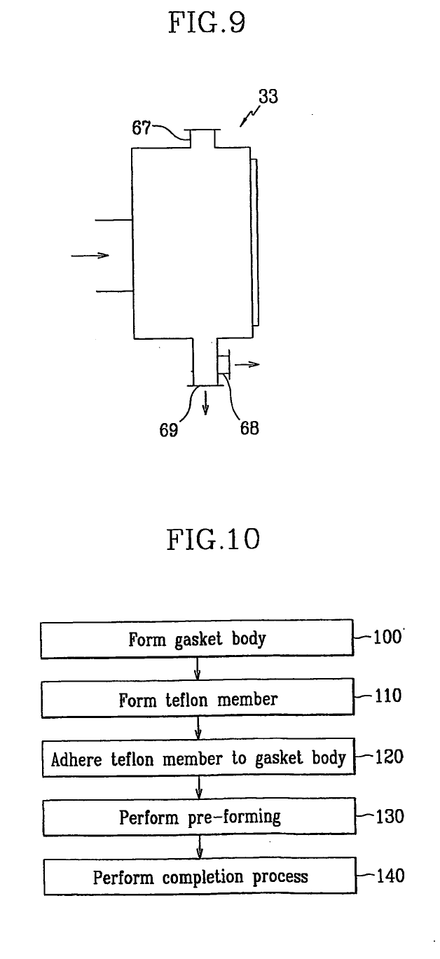

Further, the sodium hydroxide exhaust unit 33, with reference also to FIG. 9, communicates with the hydrogen gas passageways 53 of the cathode gaskets 37. The sodium hydroxide exhaust unit 33 includes a hydrogen gas exhaust hole 67 formed at upper portion of the sodium hydroxide exhaust unit 33 and through which hydrogen gas is exhausted, and a sodium hydroxide exhaust hole 68 and a circulation hole 69 formed at a lower portion of the sodium hydroxide exhaust unit 33. A pure water supply pipe 70 (see FIG. 2) is connected to a lower end of the sodium hydroxide exhaust unit 33. The pure water supply pipe 70 passes through the moveable plate 61 to communicate with the pure water passageways 52 of the cathode gaskets 37.

An operation of the gaskets and the electrolysis apparatus using the gaskets will now be described.

First, brine is supplied to the brine passageways 43 and 49 through the brine supply pipe 66, and pure water is supplied to the pure water passageways 44 and 52 through the pure water supply pipe 70. After filling the brine passageways 43 and 49, the brine fills the center openings 40 of the anode gaskets 35 through the distribution pipes 54; and after filling the pure water passageways 44 and 52, the pure water fills the center opening 51 of the anode gasket 35 through the distribution pipes 54.

In this state where the center openings 40 of the anode gaskets 35 and the center openings 51 of the cathode gaskets 37 are filled with brine and pure water, respectively, a current is applied to the left and right distribution bars 59a and 59b, and to the conducting plate 57. As a result, Na components in the brine in the cation chambers undergo electrolysis to become Na ions, and the pure water in the anion chambers undergoes electrolysis to obtain H ions and OH ions.

The Na ions pass through the ion-exchange membranes 34 and move into an adjacent anion chamber to react with the OH ions, thereby resulting in sodium hydroxide (NaOH). Occurring simultaneously with this reaction, current flows through the cathode plates 38, between which are provided the ion-exchange membranes 34, and current flows to the right anode plates 36 via the conducting plates 57 such that the sodium hydroxide reaction is again realized.

In the cation chambers, Cl ions are generated in addition to the generation of Na ions. The Cl ions combine with the Na ions such that chlorine gas is made. The chlorine gas flows into the chlorine gas passageways 45 and 50 through the exhaust pipe 55, then flows into the chlorine gas exhaust unit 32 to be expelled to outside the electrolysis apparatus 30 through the exhaust hole 63.

In the anion chambers, the generated H ions combine with each other to make hydrogen gas. The hydrogen gas enters into the hydrogen gas exhaust unit 33 through the exhaust pipe 55 together with a sodium hydroxide solution. The hydrogen gas in the hydrogen gas exhaust unit 33 is expelled to outside the electrolysis apparatus 30 through the hydrogen gas exhaust hole 67. Part of the sodium hydroxide solution is collected through the sodium hydroxide exhaust hole 68, while the rest of the sodium hydroxide solution is circulated through the circulation hole 69.

In the above process of extracting sodium hydroxide, areas that come into contact with brine and chlorine gas (i.e., areas that define the brine passageways 43 and 49 and the chlorine gas passageways 45 and 50 of the anode gaskets 35 and the cathode gaskets 37, and the center openings 40 of the anode gaskets 35) are corroded by Cl components. However, the corrosion is minimal with the use of the Teflon member 47 such that the electrolysis apparatus 30 may be used for a considerable time without encountering problems as in the prior art.

A method of producing cathode gaskets, anode gaskets, and sheet gaskets that are treated with Teflon to minimize corrosion will now be described.

First, a gasket body (a cathode gasket, anode gasket, or sheet gasket without Teflon coated thereon) is formed using rubber that is cut to desired dimensions in step 100. Through this cutting process, a cathode gasket, anode gasket, or sheet gasket is formed as described above. That is, in the case of the cathode gasket and the anode gasket, a configuration including a brine passageway, a pure water passageway, a chlorine gas passageway, and a hydrogen gas passageway to specific sides of a frame is realized as described above; and in the case of the sheet gasket, dimensions matching the size of the frames of the cathode gaskets and a structure including an opening in the center thereof is realized.

A connecting protrusion is formed at areas where Teflon will be coated. In more detail, connecting protrusions are formed at areas of the cathode gasket defining the brine passageway, a center opening, and the chlorine gas passageway; connecting protrusions are formed at areas of the anode gasket defining the brine passageway and the chlorine gas passageway; and a connecting protrusion is formed at an area of the sheet gasket defining the opening.

A Teflon member is then formed in step S110. The Teflon member is injection molded to a shape corresponding the protrusions. That is, the Teflon member is formed having a connecting groove that corresponds to the shape and size of the protrusions of the cathode gasket, anode gasket, or sheet gasket. For the Teflon member, materials that have high adhesiveness to the material used for the gaskets is used such as PTFE (polytetrafluoroethylene), ETFE, and FEP. Preferably, PTFE, which has the best adhesiveness to rubber, is used.

In more detail, PTFE powder is supplied to a reactor to undergo fusion. A resulting fused material is provided to a mold, which is set at a temperature of approximately 80° C., to perform press molding, resulting in the Teflon member having the connecting groove as described above. The Teflon member formed in this manner is then slowly cooled at room temperature. The cooled Teflon member is then cut to correspond to the size of the gasket body.

After the Teflon member is cut, the Teflon member is adhered to the gasket body in step 120. To improve the adhesiveness of the Teflon member to the gasket body, an etching process is performed on a surface of the Teflon member that will contact the gasket body. The etching process is performed using a solution realized by mixing Na and liquid ammonia. After etching is completed, an adhesive is applied to the connecting protrusion of the gasket body and to the surface of the Teflon member that will be applied to the gasket body, after which the Teflon member is applied to the protrusion of the gasket body.

Next, a pre-forming process is performed in step 130. In the pre-forming process, air pockets generated at areas of contact between the gasket body and the Teflon member as a result of minute amounts of air in the rubber generated during molding are removed. The pre-forming process is performed by supplying the gasket body and the Teflon member to a pre-forming mold (after the process of adhering the Teflon member to the gasket body), then in a state where heat from a heat source is removed, pressing is performed such that air between the gasket body and the Teflon member is removed. It is preferable that the pressure used during pressing is between 2 and 3 kgf/cm².

Lastly, a completion process is performed in step 140. In the completion process, the gasket with the Teflon member coated thereon (and in which all air has been removed between the Teflon member and the gasket body) is placed in a mold then pressing is again performed, thereby completing the production of the gasket. The pressure used during this pressing operation is between 13 and 17 kgf/cm², and preferably is 14 kgf/cm². Further, the mold is controlled to a temperature between 170 and 180° C. during the pressing operation.

In the present invention described above, the gasket, which is one of the main elements of the electrolytic cell, is treated with Teflon at areas coming into contact with brine and chlorine gas such that corrosion is significantly reduced compared to the gasket not having undergone such treatment. As a result, the costs and consumption of time involved in stopping operation of the electrolysis apparatus to replace or clean the gaskets are substantially minimized.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A method for producing a gasket, comprising:
forming a gasket body using rubber, the gasket body including a center opening and a plurality of passageways, and forming connecting protrusions at areas defining the center opening if desired and select passageways;
forming a Teflon member using an injection molding process such that the Teflon member includes a connecting groove corresponding to a shape of the connecting protrusions;
performing an etching process on a surface of the Teflon member that will contact the gasket body using a solution in which Na and liquid ammonia are mixed, applying an adhesive to the gasket body and the Teflon member at areas where the gasket body and the Teflon member are to make contact, and adhering the Teflon member to the connecting protrusions of the gasket body;
performing a pre-forming process, in which the gasket body with the Teflon member adhered thereon is placed in a mold and pressing is performed on the Teflon member such that air between the gasket body and the Teflon member is removed; and
performing a completion process, in which the gasket member with the Teflon member adhered thereon is placed in a mold and pressing is performed.

2. The method of claim 1, wherein the Teflon member is formed by supplying PTFE powder to a reactor to undergo fusion, providing a resulting fused material to a mold, performing press molding to result in the Teflon member having the connecting groove, slowly cooling the Teflon member at room temperature, and cutting the cooled Teflon member to correspond to a size of the gasket body.

3. The method of claim 2, wherein press molding is performed at a temperature of approximatly 80° C.

4. The method of claim 1, wherein pressing during the pre-forming processing is performed in a state where heat from a heat source is removed.

5. The method of claim 4, wherein a cross section of the Teflon member is substantially in the shape of a square with one side removed.

6. The method of claim 1, wherein material used for the Teflon member is selected from the group consisting of PTFE, ETFE, and FEP.

7. The method of claim 1, wherein pressing is performed during the pre-forming process using a pressure of between 2 and 33 kgf/cm².

8. The method of claim 1, wherein pressing is performed during the completion process using a pressure of between 13 and 17 kgf/cm², and at a temperature between 170 and 180° C.

9. A gasket produced using the method as in claim 1 for producing a gasket, in which areas forming passageways and a center opening coming into contact with brine and chlorine gas is treated with Teflon to result in a Teflon member having a cross section in the shape of a square with one side removed.

10. An electrolysis apparatus including a cation chamber and an anion chamber separated by an ion-exchange membrane mounted within an electrolytic chamber, in which after brine and pure water are supplied respectively to the cation chamber and the anion chamber, power is applied to a cathode plate and an anode plate mounted respectively in the cation chamber and the anion chamber to realize separation of chlorine gas, hydrogen gas, and a sodium hydroxide aqueous solution, the electrolysis apparatus comprising:
a cathode gasket including a center opening at a center of a frame that contacts the cathode plate, a brine passageway formed on a first side of the frame for allowing the passage of brine, a pure water passageway formed on the first side of the frame for allowing the passage of pure water, a chlorine gas passageway formed on a second of the frame for allowing the passage of chlorine gas, a hydrogen gas passageway formed on the second side of the frame for allowing the passage of hydrogen gas, a brine connecting hole formed at a predetermined angle with respect to a long axis of the cathode gasket and between the brine passageway and the center opening, a gas connecting hole formed substantially parallel to the long axis of the cathode gasket and between the chlorine gas passageway and the center opening, and Teflon applied to surfaces defining the brine passageway, the center opening, and the chlorine gas passageway;
an anode, gasket including a center opening at a center of a frame that contacts the anode plate, a brine passageway formed on a first side of the frame for allowing the passage of brine, a pure water passageway formed on the first side of the frame for allowing the passage of pure water, a chlorine gas passageway formed on a second side of the frame for allowing the passage of chlorine gas, a hydrogen gas passageway formed on the second side of the frame for allowing the passage of hydrogen gas, a pure water connecting hole formed at a predetermined angle with respect to a long axis of the anode gasket and between the pure water passageway and the center hole, a hydrogen gas connecting hole formed substantially parallel to the long axis direction of the anode gasket and between the hydrogen gas passageway and the center opening, and Teflon applied to surfaces defining the brine passageway and the chlorine gas passageway;
a sheet gasket mounted to an outer surface of the cathode plate to closely contact the ion-exchange membrane, an opening being formed at a center of the sheet gasket and Teflon being applied to a surface of the sheet gasket defining the opening;
a chlorine gas exhaust unit communicating with the chlorine gas passageway, the chlorine gas exhaust unit including an exhaust hole at an upper portion thereof through which chlorine gas is exhausted, and including, a waste brine exhaust hole and a circulation hole at a lower portion thereof;
a brine supply pipe connected to a lower end of the chlorine gas exhaust unit and communicated with the brine passageway;
a sodium hydroxide exhaust unit communicating with the hydrogen gas passageway, the sodium hydroxide exhaust unit including a hydrogen gas exhaust hole formed at an upper portion thereof through which hydrogen gas is exhausted, and including a sodium hydroxide exhaust hole and a circulation hole at a lower portion thereof; and
a pure water supply pipe connected to a lower end of the sodium hydroxide exhaust unit and communicating with the pure water passageway.

11. A gasket produced using the method as in claim 2 for producing a gasket, in which areas forming passageways and a center opening coming into contact with brine and chlorine gas is treated with Teflon to result in a Teflon member having a cross section in the shape of a square with one side removed.

12. A gasket produced using the method as in claim 3 for producing a gasket, in which areas forming passageways and a center opening coming into contact with brine and chlorine gas is treated with Teflon to result in a Teflon member having a cross section in the shape of a square with one side removed.

13. A gasket produced using the method as in claim 4 for producing a gasket, in which areas forming passageways and a center opening coming into contact with brine and chlorine gas is treated with Teflon to result in a Teflon member having a cross section in the shape of a square with one side removed.

14. A gasket produced using the method as in claim 5 for producing a gasket, in which areas forming passageways and a center opening coming into contact with brine and chlorine gas is treated with Teflon to result in a Teflon member having a cross section in the shape of a square with one side removed.

15. A gasket produced using the method as in claim 6 for producing a gasket, in which areas forming passageways and a center opening coming into contact with brine and chlorine gas is treated with Teflon to result in a Teflon member having a cross section in the shape of a square with one side removed.

16. A gasket produced using the method as in claim 7 for producing a gasket, in which areas forming passageways and a center opening coming into contact with brine and chlorine gas is treated with Teflon to result in a Teflon member having a cross section in the shape of a square with one side removed.

17. A gasket produced using the method as in claim 8 for producing a gasket, in which areas forming passageways and a center opening coming into contact with brine and chlorine gas is treated with Teflon to result in a Teflon member having a cross section in the shape of a square with one side removed.
